(19) United States
(12) Patent Application Publication
(10) Pub. No.: US 2006/0030376 A1
(43) Pub. Date: Feb. 9, 2006

(54) Stereophonic wireless microphone

(75) Inventor: Chia-Chun Tung, Taipei City (TW)

Correspondence Address: BACON & THOMAS, PLLC, 625 SLATERS LANE, FOURTH FLOOR, ALEXANDRIA, VA, 22314, US

(73) Assignee: BlueExpert Technology Corp., Taipei City (TW)

(21) Appl. No.: 11/011,090

(22) Filed: Dec. 15, 2004

(30) Foreign Application Priority Data
Aug. 4, 2004 (TW) 093212351

(51) Int. Cl. H04M 1/00

(52) U.S. Cl. 455/575.1; 455/41.2

(57) ABSTRACT

A stereophonic wireless microphone includes a memory module, a sound signal receiving module, a CPU, a sound information processing module and a Bluetooth wireless communication module. The memory module saves accompaniment information. The sound signal receiving module receives at least one original sound signal inputted from exterior to generate a first sound signal. The CPU electrically connected to the memory module is for processing the accompaniment information. The sound information processing module, which is electrically connected to the CPU and the sound signal receiving module, generates sound information according to the first sound signal or the accompaniment information. The Bluetooth wireless communication module, which is electrically connected to the sound information processing module, generates a wireless signal according to the sound information generated by the sound information processing module.

### CROSS REFERENCE TO RELATED APPLICATIONS

This Non-provisional application claims priority under 35 U.S.C. §119(a) on Patent Application No. 093212351 filed in Taiwan, Republic of China on Aug. 4, 2004, the entire contents of which are hereby incorporated by reference.

### BACKGROUND OF THE INVENTION

1. Field of Invention

The invention relates to a stereophonic wireless microphone.

2. Related Art

Microphones are indispensable products in many occasions, such as singing in a KTV or speaking in a larger occasion. Most early microphones are wired microphones, which only can be used when a signal line is connected to the microphone jack of the amplifier. When the microphone is used in a short distance, the user will not feel inconvenient. When the distance from the amplifier to the microphone is lengthened, it is bothersome in usage because the connection wire is too long. In addition, the modem electrical products are almost developed toward the wireless trend, so the wireless microphones are rapidly developed in correspondence with the demands in the market.

The available wireless microphone simplifies the wire connection of the microphone in many occasions. In a concert, for example, a shower does not have to limit his/her action and movable range on the stage owing to the limitation of the wired microphone, and the wireless microphone can be used more conveniently.

The conventional microphone typically utilizes a sound pickup head to collect the analog sound inputted from the exterior, and to transmit the sound to an amplifier via a transmission cable or in a wireless manner, and then a speaker outputs the sound. When the music is needed for accompaniment, the accompaniment music has to be played with the aid of another music playing device so as to obtain the effect of music accompaniment.

With the progress of the technology, however, the electrical products are also developed toward the multi-functional trend. Thus, the applications of the microphone should not be limited to the sound transfer, and the display and transmission of other accompaniment music and the accompaniment information such as images are also very important. Thus, it is an important subject of the invention to increase the suitable applications of the microphone in various occasions such that the microphone can have the advantage of multi-functions.

### SUMMARY OF THE INVENTION

In view of the foregoing, the invention is to provide a stereophonic wireless microphone capable of transferring the accompaniment music and audio and displaying the images.

To achieve the above, a stereophonic wireless microphone of the invention includes a memory module, a sound signal receiving module, a CPU (Central Processing Unit), a sound information processing module and a Bluetooth wireless communication module. The memory module saves accompaniment information. The sound signal receiving module receives at least one original sound signal inputted from the exterior to generate a first sound signal. The CPU electrically connected to the memory module is for processing the accompaniment information. The sound information processing module, which is electrically connected to the CPU and the sound signal receiving module, generates sound information according to the first sound signal or the accompaniment information. The Bluetooth wireless communication module, which is electrically connected to the sound information processing module, generates a wireless signal according to the sound information generated by the sound information processing module.

As mentioned above, the stereophonic wireless microphone of the invention transfers the accompaniment information, which is saved in the memory module, and the first sound signal, which is received by the sound signal receiving module, to the corresponding receivers through the sound information processing module and the Bluetooth wireless communication module in a wireless transmission manner. Accordingly, the stereophonic wireless microphone of the invention can have the music accompaniment function without the aid of other music playing devices.

### BRIEF DESCRIPTION OF THE DRAWINGS

The invention will become more fully understood from the detailed description given hereinbelow illustration only, and thus is not limitative of the present invention, and wherein:

FIG. 1 is a schematic illustration showing a stereophonic wireless microphone according to a first embodiment of the invention;

FIG. 2 is a schematic illustration showing a stereophonic wireless microphone according to a second embodiment of the invention; and

FIG. 3 is a schematic illustration showing a stereophonic wireless microphone according to a third embodiment of the invention.

### DETAILED DESCRIPTION OF THE INVENTION

The stereophonic wireless microphone according to the preferred embodiments of the invention will be described with reference to the accompanying drawings.

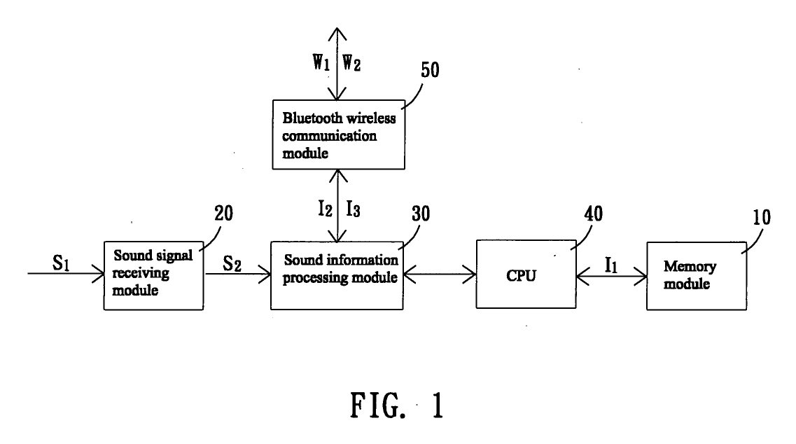

Referring to FIG. 1, the stereophonic wireless microphone according to the first embodiment of the invention includes a memory module 10, a sound signal receiving module 20, a sound information processing module 30, a CPU (Central Processing Unit) 40, and a Bluetooth wireless communication module 50.

The memory module 10 saves at least one accompaniment information I₁, which may be music information, audio information, character information or image data. In this embodiment, the accompaniment information It is the accompaniment information having the MP3 format, and the stereophonic accompaniment information. In addition, the memory module 10 may be a memory card module or a flash memory module.

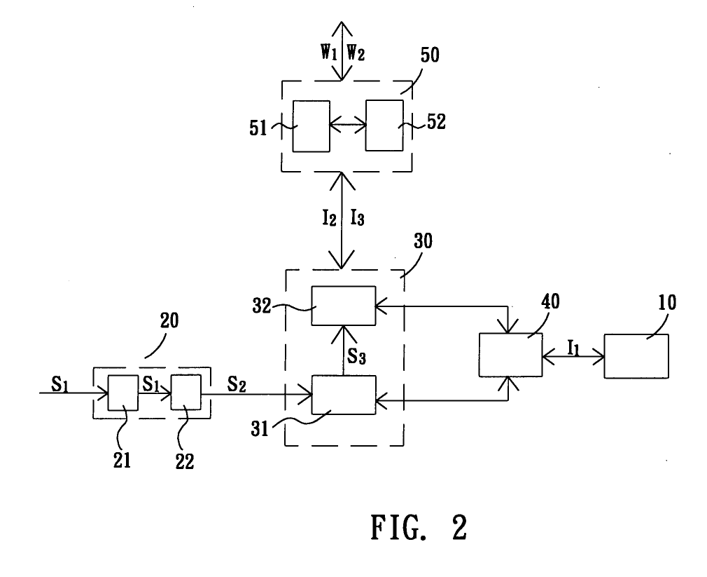

The sound signal receiving module 20 receives at least one original sound signal S₁ inputted from the exterior, and generates a first sound signal S₂. In this embodiment, the sound signal receiving module 20 further includes a sound signal receiving unit 21 and a sound signal amplifying loop 22 electrically connected to the sound signal receiving unit 21, as shown in FIG. 2. The sound signal receiving unit 21 receives the original sound signal S₁ inputted from the exterior, and transfers the original sound signal S₁ to the sound signal amplifying loop 22. The sound signal amplifying loop 22 generates the first sound signal S₂ according to the original sound signal S₁. In this embodiment, the first sound signal S₂ is a stereophonic sound signal.

The CPU 40 is electrically connected to the memory module 10 and is for processing the accompaniment information I₁. The sound information processing module 30, which is electrically connected to the CPU 40 and the sound signal receiving module 20, generates sound information I₂ according to the first sound signal S₂ or the accompaniment information I₁.

In this embodiment, the sound information processing module 30 further includes a sound information encoding/decoding loop 31 and a sound information encoding loop 32, as shown in FIG. 2. The sound information encoding/decoding loop 31 is electrically connected to the CPU 40 and the sound signal receiving module 20, and the sound information encoding loop 32 is electrically connected to the CPU 40 and the sound information encoding/decoding loop 31. The sound information encoding/decoding loop 31 generates a second sound signal S₃ according to the first sound signal S₂ generated by the sound signal receiving module 20. In addition, the sound information encoding/decoding loop 31 may also generate the second sound signal S₃ according to the accompaniment information I₁ inputted from the CPU 40. Furthermore, the sound information encoding/decoding loop 31 may also generate the accompaniment information I₁, which is transferred to the memory module 10 through the CPU 40 according to the first sound signal S₂ inputted from the sound signal receiving module 20.

The second sound signal S₃ generated by the sound information encoding/decoding loop 31 is inputted to the sound information encoding loop 32. The sound information encoding loop 32 generates the sound information I₂ according to second sound signal S_{3.} The sound information I₂ may have the PCM (Pulse Code Modulation) format.

The Bluetooth wireless communication module 50, which is electrically connected to the sound information processing module 30, generates a wireless signal W₁ according to the sound information 12 generated by the sound information processing module 30. The Bluetooth wireless communication module 50 further includes a RF (Radio Frequency) chip set 51 and a baseband chip set 52, as shown in FIG. 2. The RF chip set 51 and the baseband chip set 52 may be disposed in a single chip. In this embodiment, the Bluetooth wireless communication module 50 may further generate additional sound information I₃ for the stereophonic wireless microphone to use according to an additional wireless signal W₂ inputted from the exterior. The stereophonic wireless microphone of the invention may further exchange files with a product having the same function in a wireless transmission manner through the Bluetooth wireless communication module.

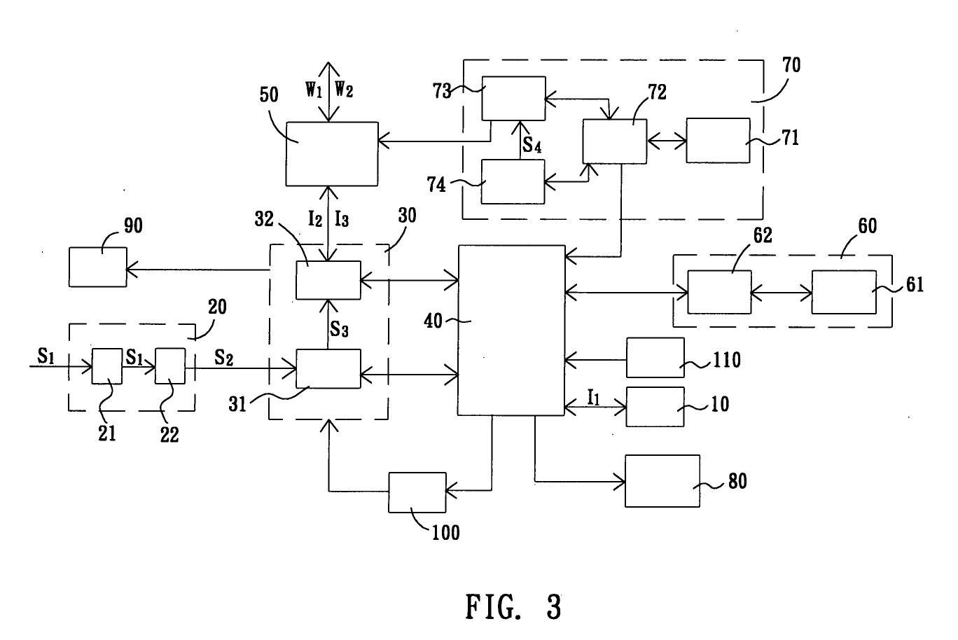

Referring to FIG. 3, the embodiment further includes a display module 60, an information transmission module 70, a power supply module 80, a sound information output connection terminal 90, a radio loop 100 and a man-machine control interface 110.

The display module 60 at least has a display 61 and a display drive loop 62, which is electrically connected to the display 61 and the CPU 40. The display 61 displays the character information or image data.

Information transmission is made between the information transmission module 70, which is electrically connected to the CPU 40 and the Bluetooth wireless communication module 50, and an exterior apparatus. The information transmission module 70 further includes a serial bus (USB) connection terminal 71, a serial bus expansion loop 72, a power voltage regulating control loop 73 and a time delay loop 74. The serial bus connection terminal 71 is to be connected to the exterior apparatus. The serial bus expansion loop 72 is electrically connected to the CPU 40 and the serial bus connection terminal 71. The serial bus expansion loop 72 expands the serial bus connection terminal 71 into at least two serial bus connection terminals for the CPU 40 and the Bluetooth wireless communication module 50 to use. The power voltage regulating control loop 73 converts the voltage value, which is provided by the serial bus expansion loop 72, into another voltage value for the Bluetooth wireless communication module 50 to use. In this embodiment, the power voltage regulating control loop 73 converts the voltage of 5 volts into the voltage of 3.3 volts for the Bluetooth wireless communication module 50 to use. The time delay loop 74 is electrically connected to the serial bus expansion loop 72 and ‘the power voltage regulating’ control loop 73, and generates a time delay control signal S₄ to control the power voltage regulating control loop 73.

The power supply module 80 provides power (e.g., 2V and 3.3V) to the module or unit, such as the CPU 40, the Bluetooth wireless communication module 50, the sound information processing module 30, or the sound signal receiving module 20, in the stereophonic wireless microphone.

The sound information output connection terminal 90, which is electrically connected to the sound information processing module 30, outputs the accompaniment information I₁ to the exterior (e.g., the earphone).

The radio loop 100, which is electrically connected to the CPU 40 and the sound information processing module 30, receives a wireless audio signal provided by the wireless broadcast channel.

The man-machine control interface 110, which is electrically connected to the CPU 40, controls the function and operation of the stereophonic wireless microphone. For example, the radio function, recording function or transmitting/receiving function may be selected.

In summary, the stereophonic wireless microphone of the invention utilizes the Bluetooth wireless technology to synchronously transfer the accompaniment information, which is saved in the memory module, and the singing sound, which is received by the sound signal receiving module, to the Bluetooth wireless communication module and then to the active speaker or amplifier. Thus, the wireless accompaniment function may be achieved without the aid of any other music playing apparatuses to play the accompaniment music. In addition, the character information (e.g., lyric) or image data in the accompaniment information may be synchronously displayed on the display through the display module in order to facilitate the operation of the user while the accompaniment music is being played. Furthermore, because the accompaniment information may be the accompaniment information with the MP3 format, the microphone may serve as a MP3 player ordinarily.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A stereophonic wireless microphone, comprising:
a memory module for saving accompaniment information;
a sound signal receiving module for receiving at least one original sound signal inputted from exterior, and thus generating a first sound signal;
a CPU (Central Processing Unit), which is electrically connected to the memory module and for processing the accompaniment information;
a sound information processing module, which is electrically connected to the CPU and the sound signal receiving module and generates sound information according to the first sound signal or the accompaniment information; and
a Bluetooth wireless communication module, which is electrically connected to the sound information processing module and generates a wireless signal according to the sound information generated by the sound information processing module.

2. The stereophonic wireless microphone according to claim 1, wherein the Bluetooth wireless communication module comprises a baseband chip set and a RF (Radio Frequency) chip set.

3. The stereophonic wireless microphone according to claim 2, wherein the baseband chip set and the RF chip set are disposed in a single chip.

4. The stereophonic wireless microphone according to claim 1, wherein the Bluetooth wireless communication module generates additional sound information for the stereophonic wireless microphone to use according to an additional wireless signal inputted from the exterior.

5. The stereophonic wireless microphone according to claim 1, wherein the sound information processing module comprises:
a sound information encoding/decoding loop, which is electrically connected to the CPU and the sound signal receiving module, and generates a second sound signal according to the first sound signal inputted by the sound signal receiving module; and
a sound information encoding loop, which is electrically connected to the sound information encoding/decoding loop and the CPU, and generates sound information with a PCM format for the Bluetooth wireless communication module to use according to the second sound signal.

6. The stereophonic wireless microphone according to claim 5, wherein the sound information encoding/decoding loop generates the second sound signal according to the accompaniment information inputted by the CPU, and the second sound signal is outputted to the sound information encoding loop.

7. The stereophonic wireless microphone according to claim 5, wherein the sound information encoding/decoding loop generates the accompaniment information, which is transferred to the memory module via the CPU, according to the first sound signal inputted by the sound signal receiving module.

8. The stereophonic wireless microphone according to claim 1, wherein the accompaniment information has a MP3 format.

9. The stereophonic wireless microphone according to claim 1, wherein the accompaniment information is music information, audio information, character information, or image data.

10. The stereophonic wireless microphone according to claim 1, wherein the sound signal receiving module comprises:
a sound signal receiving unit for receiving the at least one original sound signal inputted from the exterior, and
a sound signal amplifying loop, which is electrically connected to the sound signal receiving unit and the sound information processing module, and generates the sound signal according to the at least one original sound signal.

11. The stereophonic wireless microphone according to claim 1, further comprising a display module, which comprises a display and a display drive loop, wherein the display drive loop is electrically connected to the display and the CPU.

12. The stereophonic wireless microphone according to claim 11, wherein the display displays character information or image data.

13. The stereophonic wireless microphone according to claim 1, further comprising an information transmission module, which is electrically connected to the CPU and the Bluetooth wireless communication module and is for transmitting information to an exterior apparatus.

14. The stereophonic wireless microphone according to claim 13, wherein the information transmission module comprises:
a serial bus connection terminal to be electrically connected to the exterior apparatus;
a serial bus expansion loop, which is electrically connected to the CPU and the serial bus connection terminal and expands the serial bus connection terminal into at least two serial bus connection terminals for the CPU and the Bluetooth wireless communication module to use;
a power voltage regulating control loop for converting a voltage value, which is provided by the serial bus expansion loop, into another voltage value for the Bluetooth wireless communication module to use; and
a time delay loop, which is electrically connected to the serial bus expansion loop and the power voltage regulating control loop and generates a time delay control signal to control the power voltage regulating control loop.

15. The stereophonic wireless microphone according to claim 1, further comprising a power supply module for supplying power to the CPU, the Bluetooth wireless communication module, the sound information processing module and the sound signal receiving module.

16. The stereophonic wireless microphone according to claim 1, further comprising a sound information output connection terminal, which is electrically connected to the sound information processing module and is for outputting the accompaniment information to the exterior.

17. The stereophonic wireless microphone according to claim 1, further comprising a radio loop, which is electrically connected to the CPU and the sound information processing module, and is for receiving a wireless audio signal provided by a wireless broadcast channel.

18. The stereophonic wireless microphone according to claim 1, further comprising a man-machine control interface, which is electrically connected to the CPU, and is for controlling functions and operations of the stereophonic wireless microphone.

19. The stereophonic wireless microphone according to claim 1, wherein the first sound signal is a stereophonic sound signal.

20. The stereophonic wireless microphone according to claim 1, wherein the accompaniment information is stereophonic accompaniment information.
